(19) United States
(12) Patent Application Publication
(10) Pub. No.: US 2021/0207411 A1
(43) Pub. Date: Jul. 8, 2021

(54) CLOSURE LATCH ASSEMBLY WITH POWER-OPERATED LATCH RELEASE MECHANISM HAVING ELECTROMAGNETIC ACTUATOR

(71) Applicant: MAGNA CLOSURES INC., Newmarket (CA)

(72) Inventors: Francesco CUMBO, Pisa (IT); John Glenn ZEABARI, Highland, MI (US)

(21) Appl. No.: 17/142,992

(22) Filed: Jan. 6, 2021

Related U.S. Application Data
(60) Provisional application No. 62/958,147, filed on Jan. 7, 2020.

(51) Int. Cl. E05B 81/08; E05B 81/16; E05B 81/74; E05B 83/36; E05B 81/30

(52) U.S. Cl. CPC E05B 81/08; E05B 81/16; E05B 81/74; E05B 83/36; E05Y 2900/531; E05Y 2201/42; E05Y 2201/462; E05Y 2201/686; E05Y 2400/32; E05B 81/30

(57) ABSTRACT

A closure latch assembly includes a latch mechanism having a pawl moveable between a ratchet holding position, whereat a ratchet is maintained in a striker capture position, and a ratchet release position, whereat the ratchet is biased toward a striker release position. An electromagnetic actuator includes a first member, a second member, a plurality of permanent magnets fixed to one of the first and second members and a plurality of electromagnetic coils fixed to the other of the first and second members. The electromagnetic coils are energizable to attract and repel the plurality of permanent magnets to move the first member relative to the second member, whereupon the relative movement causes at least one of the following actuations: movement of the pawl between the ratchet holding and ratchet release positions; locking the pawl against movement from the ratchet holding position to the ratchet release position; and cinching the ratchet in the striker capture position.

### CROSS-REFERENCE TO RELATED APPLICATION

This application claims the benefit of U.S. Provisional Application Ser. No. 62/958,147, filed Jan. 7, 2020, which is incorporated herein by reference in its entirety.

### FIELD

The present disclosure relates to generally to power-operated closure latch assemblies of the type used in closure systems for releasably latching a closure panel to a body portion of a motor vehicle. More particularly, the present disclosure is directed to a closure latch assembly with a mechanism having an electromagnetic actuator.

### BACKGROUND

This section provides background information which is not necessarily prior art to the inventive concepts embodied in the present disclosure.

Continued increases in technology, driven by consumer demand for advanced comfort and convenience features, has resulted in more electronics being integrated in modern motor vehicles. To this end, electronic controllers and electronically-controlled devices are now used to control a wide variety of functions in the vehicle. For example, many modern vehicles are now equipped with a passive (i.e. “keyless”) entry system to permit locking/unlocking and release of closure panels (i.e. doors, tailgates, liftgates, decklids, etc.) without the use of a traditional key-type entry system. In this regard, some popular functions and mechanisms therefor, now available with such passive entry systems, include power lock/unlock, power cinch, and power release. Thus “powered” functions and mechanisms are provided by a closure latch assembly mounted to the closure panel and which is equipped with a latch module having a ratchet/pawl type of latch mechanism that is selectively actuated via actuation of at least one electric motor actuator.

A latch control unit is electronically connected to the electric motor actuator for controlling actuation of the electric motor actuator.

Movement of the closure panel from an open position toward a closed position results in a striker (mounted to a structural portion of the vehicle) engaging and forcibly rotating the ratchet, in opposition to a biasing force normally applied to the ratchet via a ratchet biasing member, from a striker release position toward a striker capture position. Once the ratchet is located in its striker capture position, the pawl moves, due to the urging of a pawl biasing member, into a ratchet holding position whereat the pawl mechanically engages and holds the ratchet in its striker capture position, thereby latching the latch mechanism and holding the closure panel in its closed position. A latch release mechanism, operably coupled to the electric motor actuator via a gear train, is commonly associated with the latch module for causing movement of the pawl from its ratchet holding position into a ratchet releasing position. Thereafter, the ratchet biasing member drives the ratchet back to its striker release position, thereby releasing the latch mechanism and permitting movement of the closure panel to its open position.

Closure latch assemblies providing powered features, such as a power release feature, power cinch feature and/or power lock feature, typically have the electric “power release/cinch/lock” motor actuator(s) configured to actuate the power latch mechanism for releasing, cinching and/or locking the power latch mechanism. The electric motor actuator and gear train are part of the latch module, wherein the electric motor actuator is controlled via the latch control unit in response to a signal, such as latch release, cinch and/or lock/unlock signal, generated by the passive entry system (i.e. via a key fob or a handle-mounted switch). The electric motor actuator and gear train, such as in the latch release mechanism, are mechanically coupled to the pawl, such as via gears, cams, levers, and the like, to effect mechanically driven movement of the pawl between the ratchet holding and ratchet releasing positions. Although the mechanical actuation of pawl can prove effective at moving the pawl between the ratchet holding and ratchet releasing positions, certain inefficiencies and undesirable aspects can arise. For example, movement of the gears within the gear train and components coupled therewith can result in unwanted noise; frictional interaction between the gears and component parts couple with the gears can result in undesirable wear, which in turn can result in positional inaccuracies, jamming and/or fracture of component parts; anticipated wear can cause the need for intricate, costly position sensors; and further, having to accommodate gears and component parts between the gears and the pawl increases the size and weight of the closure latch assembly, which in turn can adversely affect fuel economy and design freedom of a closure panel assembly.

In view of the above, there is a recognized need to develop a closure latch assembly and actuator therefor that is reliable, repeatable, free of mechanical inefficiencies, wear resistant, quiet, cost effective in manufacture, in assembly and in use, and that exhibits a long and useful life. Moreover, while current power-operated closure latch assemblies are sufficient to meet all regulatory requirements and provide the desired consumer expectations for enhanced comfort and convenience, a need exists directed toward advancing the technology and providing alternative power-operated closure latch assemblies that address and overcome at least some of the known shortcomings associated with conventional arrangements.

### SUMMARY

This section provides a general summary of various aspects, features and structural embodiments provided by or associated with the inventive concepts hereinafter disclosed in accordance with the present disclosure and is not intended to be a comprehensive summation and/or limit the interpretation and scope of protection afforded by the claims.

In accordance with an aspect of this disclosure, there is described a latch mechanism including a ratchet and a pawl, the ratchet being moveable between a striker capture position and a striker release position, the pawl being moveable between a ratchet holding position and a ratchet release position, the pawl in the ratchet holding position holds the ratchet in the striker capture position and the pawl in the ratchet release position releases the ratchet for movement toward the striker release position, and an electromagnetic actuator, the electromagnetic actuator is operably coupled to the pawl and is adapted to move the pawl between the striker capture position and the striker release position in response to energization of the electromagnetic actuator.

In accordance with an aspect of this disclosure, a closure latch assembly is provided that overcomes at least those drawbacks discussed above with known closure latch assemblies.

In a related aspect, a closure latch assembly constructed in accordance with the disclosure includes an electromagnetic actuator operably coupled to a latch mechanism to facilitate actuating the latch mechanism without a mechanical coupling mechanism.

In a related aspect, a closure latch assembly constructed in accordance with the disclosure includes an electromagnetic actuator operably coupled to a latch mechanism to facilitate actuating the latch mechanism without a mechanical gear train.

In another aspect, the electromagnetic actuator is actuatable via an ECU controlling actuation.

In another aspect, a method of facilitating a powered actuation of a latch mechanism of a closure latch assembly without a mechanical mechanism operably coupling an actuator to the latch mechanism is provided.

In a related aspect, a method of facilitating a powered actuation of a latch mechanism of a closure latch assembly without a mechanical gear train is provided.

In accordance with these and other aspects, a closure latch assembly of the present disclosure has a latch mechanism including a ratchet and a pawl. The ratchet is moveable between a striker capture position and a striker release position. The pawl is moveable between a ratchet holding position, whereat the ratchet is held in the striker capture position, and a ratchet release position, whereat the ratchet is released for movement toward the striker release position. The closure latch assembly has an electromagnetic actuator including a first member, a second member, a plurality of permanent magnets fixed to one of the first member and the second member and a plurality of electromagnetic coils fixed to the other of the first member and the second member. The plurality of electromagnetic coils are configured in electrical communication with a source of alternating current. The electromagnetic coils are energizable to attract the plurality of permanent magnets in response to the alternating current and to repel the plurality of permanent magnets in response to the alternating current to move the first member relative to the second member. The latch mechanism is operably coupled to the first member to perform at least one of the following actuations in response to movement of the first member relative to the second member: move the pawl between the ratchet holding position and the ratchet release position; releasably lock the pawl against movement from the ratchet holding position to the ratchet release position; and cinch the ratchet to the striker capture position.

In accordance with another aspect, the latch mechanism can include a latch release mechanism, wherein movement of the first member relative to the second member via energization of the electromagnetic coils causes the latch release mechanism to move the pawl between the ratchet holding position and the ratchet release position.

In accordance with another aspect, the first member can be configured to move along a straight linear path relative to the second member.

In accordance with another aspect, the second member can be provided having a channel and the first member can be configured to slide along the channel in guided fashion.

In accordance with another aspect, the electromagnetic coils can be provided to extend along opposite sides of the channel to facilitate movement of the first member along the channel.

In accordance with another aspect, the plurality of permanent magnets are provided including opposite polarity permanent magnets arranged in alternating polarities relative to one another.

In accordance with another aspect, the first member can be configured to move along an arcuate path relative to the second member, wherein the arcuate path can be circular.

In accordance with another aspect, the electromagnetic coils can be arranged in a circle in radially aligned fashion with the permanent magnets to facilitate rotation of the first member relative to the second member.

In accordance with another aspect, the latch release mechanism can be provided as a link arm that operably couples the first member to the pawl, with the link arm having a slot extending between a first drive end and a second drive end, with the first member having a drive pin configured for sliding movement within the slot between the first drive end and the second drive end.

In accordance with another aspect, an electronic control unit can be configured in electrical communication with the electromagnetic coils to signal selective actuation of the electromagnetic coils.

In accordance with another aspect of the disclosure, a method of configuring a latch mechanism of a closure latch assembly of a motor vehicle closure panel for actuation so that the latch mechanism performs at least one of the following: moves a pawl between a ratchet holding position and a ratchet release position; releasably locks the pawl against movement from the ratchet holding position to the ratchet release position; and cinches a ratchet in a striker capture position, is provided. The method includes: providing an electromagnetic actuator including a first member, a second member, a plurality of permanent magnets fixed to one of the first member and the second member and a plurality of electromagnetic coils fixed to the other of the first member and the second member. Further, configuring the plurality of electromagnetic coils in electrical communication with a source of electric current such that the electromagnetic coils are energizable to attract the plurality of permanent magnets and to repel the plurality of permanent magnets in response to the electric current to move the first member relative to the second member. Further yet, operably coupling the first member to a component of the latch mechanism for selective movement of the component in response to movement of the first member.

In accordance with another aspect, the method can include providing the component of the latch mechanism to include at least one of the pawl and the ratchet, such that movement of the first member relative to the second member via energization of the electromagnetic coils causes at least one of movement of the pawl between the ratchet holding position and the ratchet release position and movement of the ratchet from the secondary striker capture position to the primary striker capture position.

In accordance with another aspect, the method can include providing the component of the latch mechanism as a latch release mechanism, such that movement of the first member relative to the second member via energization of the electromagnetic coils causes the latch release mechanism to move the pawl between the ratchet holding position and the ratchet release position.

In accordance with another aspect, the method can include configuring the first member to move linearly relative to the second member.

In accordance with another aspect, the method can include configuring the first member to rotate relative to the second member.

In accordance with another aspect of the disclosure, a method of manufacturing a closure latch assembly is provided. The method includes supporting a ratchet in a housing for movement between a striker capture position and a striker release position. Further, supporting a pawl in the housing for movement between a ratchet holding position, whereat the ratchet is in the striker capture position, and a ratchet releasing position, whereat the ratchet is released for movement toward the striker release position, and biasing the pawl toward the striker release position. The method further includes supporting an electromagnetic actuator in the housing with the electromagnetic actuator including a first member, a second member, a plurality of permanent magnets fixed to one of the first member and the second member and a plurality of electromagnetic coils fixed to the other of the first member and the second member. The plurality of electromagnetic coils are configured in electrical communication with a source of electric current of alternating first and second polarities and are energizable to attract the plurality of permanent magnets in response to the first polarity electric current and to repel the plurality of permanent magnets in response to the second polarity electric current to move the first member relative to the second member. Further yet, the method includes operably coupling a latch mechanism to the first member and configuring the latch mechanism to perform at least one of the following in response to movement of the first member relative to the second member: move the pawl between the ratchet holding position and the ratchet release position; releasably lock the pawl against movement from the ratchet holding position to the ratchet release position; and cinch the ratchet to the striker capture position.

In accordance with another aspect, the method can include configuring the latch mechanism having a latch release mechanism such that movement of the first member relative to the second member via energization of the electromagnetic coils causes the latch release mechanism to move the pawl between the ratchet holding position and the ratchet release position.

In accordance with another aspect, the method can include configuring the first member to move linearly straight relative to the second member.

In accordance with another aspect, the method can include configuring the first member to rotate relative to the second member.

In accordance with a further aspect of the present disclosure, there is described a method of configuring a latch mechanism of a closure latch assembly of a motor vehicle closure panel for actuation, the method comprising the steps of providing an electromagnetic actuator including a first member, a second member, a plurality of permanent magnets fixed to one of the first member and the second member and a plurality of electromagnetic coils fixed to the other of the first member and the second member, configuring the plurality of electromagnetic coils in electrical communication with a source of electric current such that the electromagnetic coils are energizable to attract the plurality of permanent magnets and to repel the plurality of permanent magnets to move the first member relative to the second member, and operably coupling the first member to a component of the latch mechanism using a direct drive connection for movement of the component in response to movement of the first member.

In accordance with still a further aspect of the present disclosure, there is described a power actuation system for a closure latch assembly comprising a latch mechanism including an electromagnetic actuator operably coupled to the latch mechanism, a source configured in electrical communication with the electromagnetic actuator, where the source is adapted to control a supply of alternating electric power to energize the electromagnetic actuator for actuating the latch mechanism.

These and other aspects and areas of applicability will become apparent from the description provided herein. The description and specific examples in this summary are solely intended for purpose of illustration and are not intended to limit the scope of the present disclosure. The drawings that accompany the detailed description are described below.

### BRIEF DESCRIPTION OF THE DRAWINGS

The drawings described herein are for illustrative purposes only of selected non-limiting embodiments and not all possible or anticipated implementations thereof, and are not intended to limit the scope of the present disclosure.

FIG. 1A is an isometric view of a motor vehicle equipped with a closure system including a closure latch assembly shown mounted to a vehicle door;

FIG. 1B is a system block diagram of an electronic control circuit of the closure system of FIG. 1A;

FIG. 2 is an isometric view of a closure latch assembly adapted for use in the closure system shown in FIG. 1 and which is configured to include an electromagnetic actuator constructed to embody the inventive concepts of the present disclosure;

FIGS. 3A through 3D illustrate a non-limiting example embodiment of a latch mechanism of the closure latch assembly of FIG. 2;

FIG. 4 is an isometric view of a closure latch assembly constructed according to a first embodiment of the present disclosure with a cover removed to illustrate a linear electromagnetic actuator operably coupled to a pawl of the closure latch assembly; power actuation system

FIG. 4A to FIG. 4D illustrate different configurations of a power actuation system for the closure system of FIG. 1A, in accordance with aspects of the present disclosure

FIG. 5 is an example electromagnetic actuator as a rotative piezoelectric motor optionally including an embedded positional sensing configuration such as an encoder;

FIGS. 5A-5D illustrate plan views of a closure latch assembly constructed according to a second embodiment of the present disclosure with a cover removed to illustrate a rotary electromagnetic actuator operably coupled to a pawl of the closure latch assembly, wherein;

FIG. 5A illustrates various components of a latch mechanism in a fully latched position with a latch release mechanism and various components of the rotary electromagnetic actuator shown in a latched, rest position;

FIG. 5B illustrates the various components of the latch mechanism of FIG. 5A remaining in the fully latched position with the latch release mechanism and the various components of the rotary electromagnetic actuator of FIG. 5A being moved in a pre-travel state;

FIG. 5C illustrates the various components of the latch mechanism of FIG. 5B moved toward a latch release position in response to the various components of the rotary electromagnetic actuator being moved to a latch release point;

FIG. 5D illustrates the various components of the latch mechanism of FIG. 5C moved fully to the latch release position in response to the various components of the rotary electromagnetic actuator being moved fully to the latch release point;

FIG. 6 illustrates a functional block diagram of a source of electric power for an electromagnetic actuator, in accordance with aspects of the present disclosure;

FIGS. 6A-6C illustrate schematic plan views of a closure latch assembly constructed according to a third embodiment of the present disclosure with a cover removed to illustrate a rotary electromagnetic actuator operably coupled to a pawl of the closure latch assembly, wherein;

FIG. 6A illustrates various components of a latch mechanism in a fully latched position with a latch release mechanism and various components of the rotary electromagnetic actuator shown in a latched, rest position;

FIG. 6B illustrates the various components of the latch mechanism of FIG. 6A moved toward a latch release position in response to the various components of the rotary electromagnetic actuator being moved to a latch release point;

FIG. 6C illustrates the various components of the latch mechanism of FIG. 6B moved fully to the latch release position in response to the various components of the rotary electromagnetic actuator being moved fully to the latch release point;

FIG. 6D illustrates a flow diagram of a method of releasing the latch mechanism of FIGS. 6A-6C in accordance with another aspect of the disclosure;

FIGS. 7A-7C illustrate schematic plan views of the closure latch assembly of FIGS. 6A-6C during a power reset operation, wherein;

FIG. 7A illustrates an initial stage of the power reset operation;

FIG. 7B illustrates a final stage of the power reset operation in accordance with one aspect of the disclosure;

FIG. 7C illustrates a final stage of the power reset operation in accordance with another aspect of the disclosure;

FIG. 7D illustrates a flow diagram of a method of resetting the latch mechanism of FIGS. 7A-7C after performing a power release in accordance with another aspect of the disclosure;

FIGS. 8A-8C illustrate schematic plan views of the closure latch assembly of FIGS. 6A-6C during a power cinching operation, wherein;

FIG. 8A illustrates the closure latch assembly in a fully released state prior to initiating the power cinch operation;

FIG. 8B illustrates an initial stage of the power cinch operation;

FIG. 8C illustrates a final stage of the power cinch operation;

FIG. 8D illustrates a flow diagram of a method of cinching the latch mechanism of FIGS. 8A-8C in accordance with another aspect of the disclosure;

FIG. 9 illustrates a method for assembling the actuator module;

FIG. 10 illustrates a method of assembling an actuator module, in accordance with an illustrative embodiment; and

FIG. 11 is a system diagram of a power actuation system in accordance with an illustrative embodiment of the present disclosure.

Corresponding reference numbers are used to indicate corresponding components throughout the several views associated with the above-identified drawings.

### DETAILED DESCRIPTION OF EXAMPLE EMBODIMENTS

Example embodiments of a closure latch assembly and electromagnetic actuator therefor will now be described more fully with reference to the accompanying drawings. To this end, the example embodiments are provided so that this disclosure will be thorough, and will fully convey its intended scope to those who are skilled in the art. Accordingly, numerous specific details are set forth such as examples of specific components, devices, and methods, to provide a thorough understanding of embodiments of the present disclosure. However, it will be apparent to those skilled in the art that specific details need not be employed, that example embodiments may be embodied in many different forms, and that neither should be construed to limit the scope of the present disclosure. In some example embodiments, well-known processes, well-known device structures, and well-known technologies are not described in detail.

In the following detailed description, the expression “closure latch assembly” will be used to generally, as an illustrative example, indicate any power-operated latch device adapted for use with a vehicle closure panel to provide a “powered” (i.e. release, cinch, lock/unlock, etc.) feature. Additionally, the expression “closure panel” will be used to indicate any element moveable between an open position and at least one closed position, respectively opening and closing an access to an inner compartment of a motor vehicle and therefore includes, without limitations, decklids, tailgates, liftgates, bonnet lids, and sunroofs in addition to the sliding or pivoting side passenger doors of a motor vehicle to which the following description will make explicit reference, purely by way of example.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “compromises,” “comprising,” “including,” and “having,” are inclusive and therefore specify the presence of stated features, integers, steps, operations, elements, and/or components, but do not preclude the presence or addition of one or more other features, integers, steps, operations, elements, and/or components, but do not preclude the presence or addition of one or more other features, integers, steps operations, elements, components, and/or groups thereof. The method steps, processes, and operations described herein are no to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

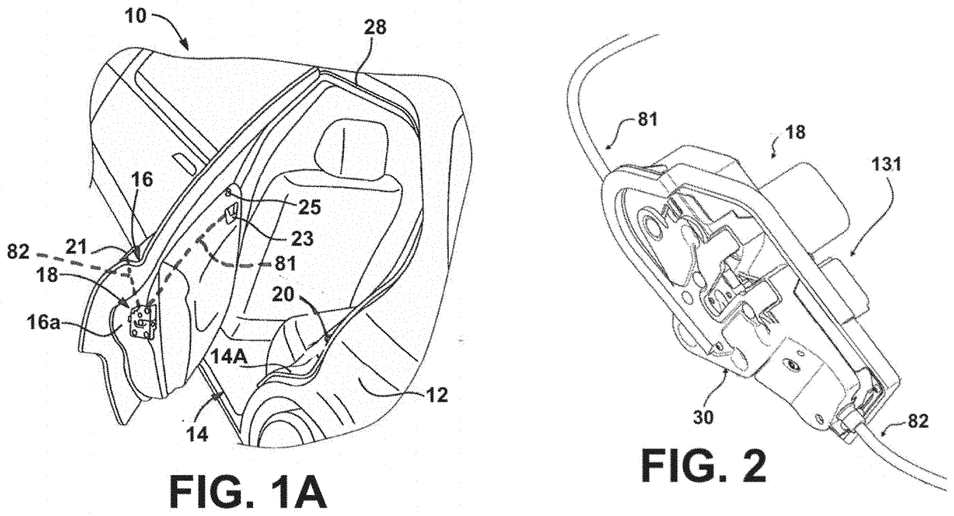

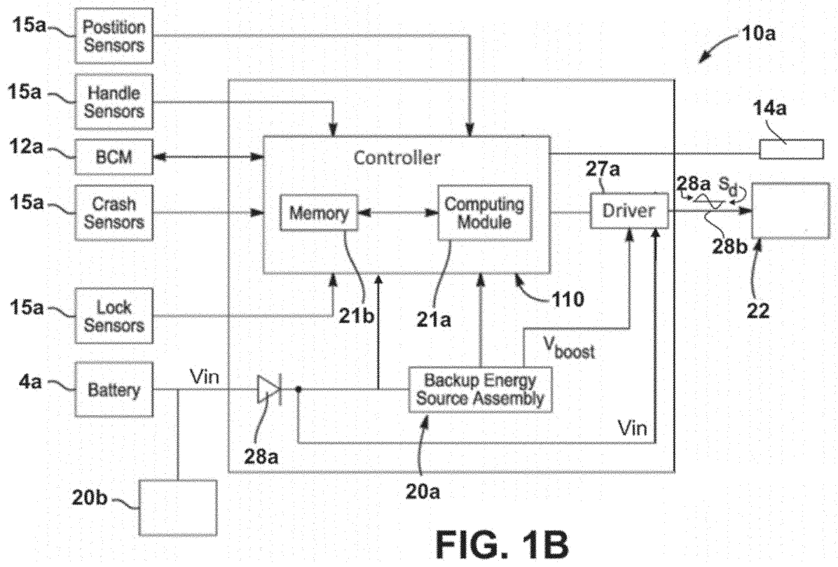

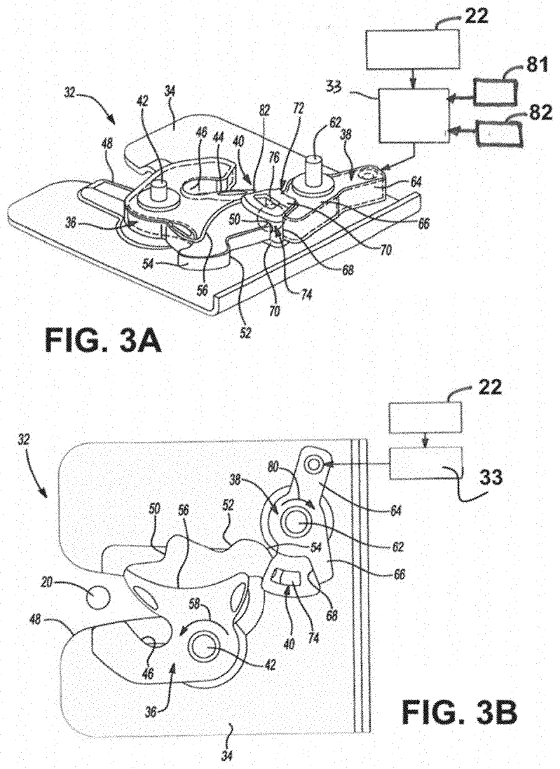

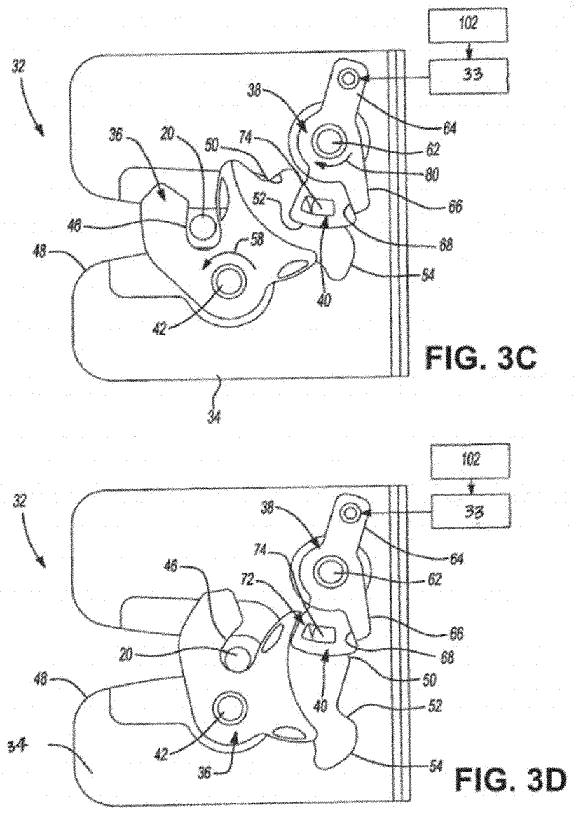

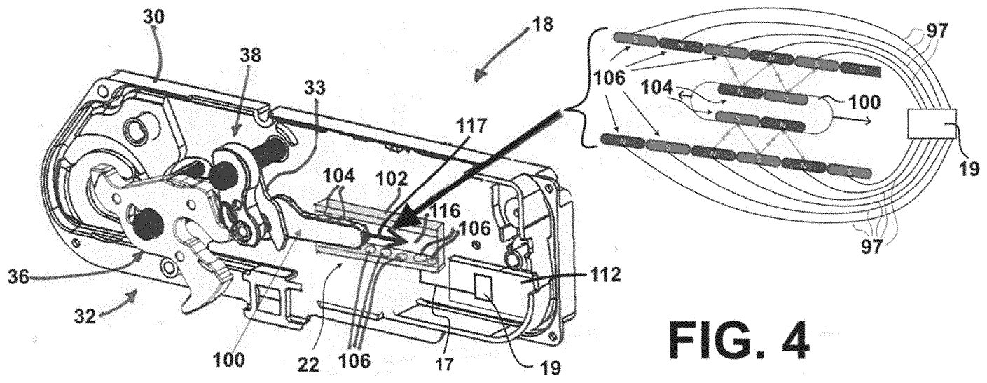

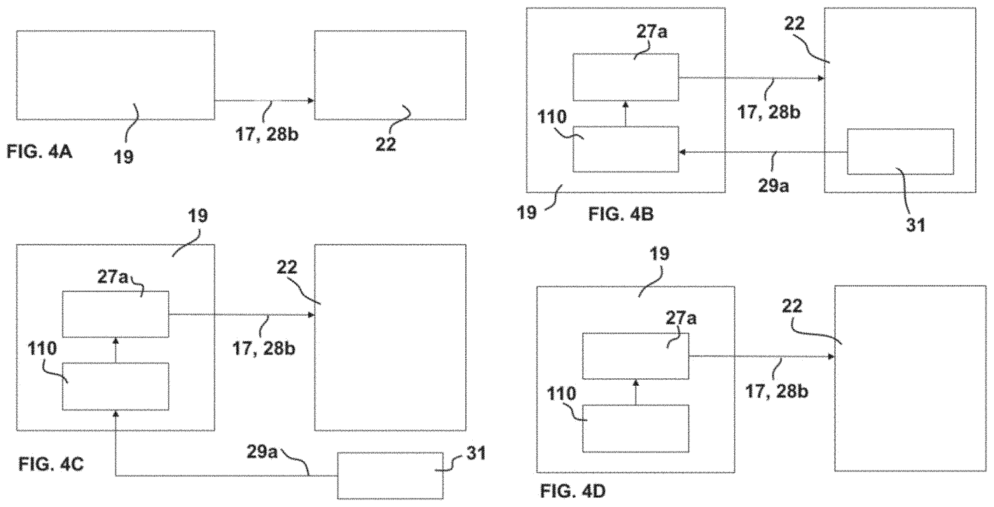

Referring initially to FIG. 1A of the drawings, a motor vehicle 10 is shown to include a vehicle body 12 defining an opening 14 to an interior passenger compartment. A closure panel 16 is pivotably mounted to body 12 for movement between an open position (shown), a partially-closed position, and a fully-closed position relative to opening 14. A closure latch assembly 18 is rigidly secured to closure panel 16 adjacent to an edge portion 16A thereof and is releasably engageable with a striker 20 that is fixedly secured to a recessed edge portion 14A of opening 14. As will be detailed, closure latch assembly 18 is generally comprised of a latch mechanism 32 (FIGS. 3A-3D and 4) and a power release actuator, also referred to as actuator mechanism 22 (shown schematically in FIGS. 3A-3D and shown in FIG. 4), wherein actuator mechanism 22 is selectively (intentionally) actuatable to move various components of latch mechanism 32, as desired to bring closure latch assembly 18 to a desired state. Latch mechanism 32 is operable to engage striker 20 and releaseably hold closure panel 16 in one of its partially-closed and fully-closed positions. An outside handle 21 and an inside handle 23 are provided for actuating (i.e. mechanically and/or electrically) closure latch assembly 18 to release striker 20 and permit subsequent movement of closure panel 16 to its open position. An optional lock knob 25 is shown which provides a visual indication of the locked state of closure latch assembly 18 and which may also be operable to mechanically change the locked state of closure latch assembly 18. A weather seal 28 is mounted on edge portion 14A of opening 14 in vehicle body 12 and is adapted to be resiliently compressed upon engagement with a mating sealing surface on closure panel 16 when closure panel 16 is held by closure latch assembly 18 in its fully-closed position so as to provide a sealed interface therebetween to prevent entry of rain and dirt into the passenger compartment while minimizing audible wind noise. For purpose of clarity and functional association with motor vehicle 10, the closure panel is hereinafter referred to as door 16.

Referring now to FIG. 1B, the closure latch assembly 18 may include an electronic control circuit 10a that is, either directly, and/or indirectly via a vehicle management unit 12a, coupled to a plurality of sensors 15a (shown schematically) of the motor vehicle 10, such as: handle-reading sensors (which read actuation of external and/or internal handles), crash sensors, lock switch sensors, and the like. The electronic control circuit 10a may also directly receive feedback information about the latch actuation from position sensors 14a, such as Hall sensors, configured to detect the operating position, for example of the ratchet 36 and/or pawl 38 (via magnet 137) for example, as will be further described herein below. The electronic control circuit 10a is also coupled to the main power supply 4a of the motor vehicle 10, so as to receive an input voltage (Vin); the electronic control circuit 10a is thus able to check if the value of the voltage Vin decreases below a predetermined threshold value, to promptly determine if an emergency or crash condition (when a backup energy source subassembly 20a may be needed) occurs. Backup energy source subassembly 20a may be provided remote from the latch housing 30, and in other locations, as indicated by reference numeral 20b. Backup energy source subassembly 20a may be provided within or part of the latch housing 30. So, the electronic control circuit 10a includes the backup energy source subassembly 20a (e.g., within the latch housing 30), which is configured to supply electrical energy or power to the power release actuator 22 associated with the latch release mechanism 33 as will be described in more details herein below, and to the electronic control circuit 10a, in case of failure or interruption of the main power supply from the main power supply 4a of the motor vehicle 10. In more detail, the electronic control circuit 10a includes a latch controller, also referred to as electronic control unit 110 (ECU), for example provided with a microcontroller, microprocessor or analogous computing module 21a, coupled to the main power supply 4a, the backup energy source subassembly 20a and the power release actuator 22, to control their operation. The electronic control circuit 10a also includes an output module, such as driver module 27a controlled by the latch controller 110. Driver module 27a is controlled by the latch controller 110 so as to generate a driving signal 28a via a signal line 28b to be supplied to the power release actuator 22 such that power release actuator 22 receives electric power. Such a signal may be an alternating chopped pulsed signal, an alternating continuous signal, or a alternating varying phase signal, as examples. Driving signal 28a may supply power in the form of an alternating AC current. A source of electric power supplied to the power release actuator 22 is illustratively shown in one possible configuration as the controller 110 controlling the driving driver module 27a for modifying the power supply 4a input (Vin) into an alternating power signal, such as an alternating current. It should be understood that the output module 27a may be an integrated circuit, be constructed of discrete components, or even integrated with other elements of the electronic control circuit 10a. In addition, one or more additional driver modules 27a can be used to separately control the operation of multiple electromechanical actuators, such as for a cinch function, as further described herein below. A main power diode 28a is connected in between the main power supply 4a and the backup energy source subassembly 20a to ensure current only flows away from the main power supply 4a (i.e., its cathode terminal is connected to the backup energy source subassembly 20a and its anode terminal is connected to the main power source 4a for receiving Vin). The latch controller 110 has an embedded memory 21b, for example a non-volatile random access memory 21b, coupled to a computing module 21a, storing suitable programs and computer instructions (for example in the form of a firmware) encompassing algorithms for execution by the computing module 21a of the actuator and latch mechanism monitoring and control methods and techniques as described herein. For example, instructions and code stored on the embedded memory 21b may also be related to various system modules, for example application programming interfaces (API) modules, drive API, digital input output API, Diagnostic API, Communication API, and communication drivers for LIN communications and CAN bus communications with the Body control module (BCM) 12a or other vehicle systems. While modules or units may be described as being loaded into the embedded memory 21b, it is understood that the modules or units could be implemented in hardware and/or software. It is recognized that the latch controller 110 may alternatively comprise a logical circuit of discrete components to carry out the functions of the computing module 21a and memory 21b. According to another aspect, the backup energy source subassembly 20a includes a group of low voltage supercapacitors (hereinafter supercap group), as an energy supply unit (or energy tank) to provide power backup to the latch assembly 18, 118, 218, even in case of power failures. Supercapacitors may include electrolytic double layer capacitors, pseudocapacitors or a combination thereof. While the backup energy source subassembly 20a can include the supercap group, it should be appreciated that the backup energy source subassembly 20a can include a battery, such as a lithium battery, or other energy storage device. Supercapacitors advantageously provide high energy density, high output current capability and have no memory effects; moreover, supercapacitors have small size and are easy to integrate, have extended temperature range, long lifetime and may withstand a very high number of charging cycles. Supercapacitors are not toxic and do not entail explosive or fire risks, thus being suited for hazardous conditions, such as for automotive applications. Latch controller 110, super capacitors, driver module 27a and other components may be mounted on a printed circuit board 112, or multiple printed circuit boards, within a housing 30 of the latch assembly 18, 118, 218.

Closure latch assembly 18 generally includes a latch housing 30 (FIG. 2) within which the components of latch mechanism 32, actuator mechanism 22 and a latch release mechanism 33 are supported. Latch housing 30 may be formed from a plastic molded component. Alternatively, latch housing 30 may be formed from a metallic material for enclosing at least the electromagnetic actuator 22 and associated control circuity 10a. For purposes of illustration only, a non-limiting version of latch mechanism 32 is shown in FIGS. 3A-3D, generally include a latch frame plate 34, ratchet 36, and a pawl 38 having a roller-type engagement device 40, by way of example and without limitation. Ratchet 36 is supported on latch frame plate 34 by a ratchet pivot post 42 for movement between a released or “striker release” position (FIG. 3B), a soft close or “secondary striker capture” position (FIG. 3C), and a hard close or “primary striker capture” position (FIGS. 3A and 3D). Ratchet 36 includes a striker guide channel 44 terminating in a striker retention cavity 46. As seen, latch frame plate 34 includes a fishmouth slot 48 aligned to accept movement of striker 20 relative thereto upon movement of door 16 toward its closed positions. Ratchet 36 includes a primary latch notch 50, a secondary latch notch 52, and a peripheral edge surface 54. A raised guide surface 56 is also formed on ratchet 36, by way of example and without limitation. Arrow 58 indicates a ratchet biasing member that is arranged to normally bias ratchet 36 toward its striker release position. Closure latch assembly 18 includes an electrical interface, such as a connector assembly 131 having a plurality of male pins for example, for establishing electrical connections with the external sensors 15a, external controller 12a, and a power supply 4a, 20b for connection with the electronic control circuit 10a, via coupling with a female connector and a bundle of signal wires or lines connected thereto.

Pawl 38 is shown pivotably mounted to latch frame plate 34 about a pawl pivot post 62 and includes a first pawl leg segment 64 and a second pawl leg segment 66 defining a pawl engagement surface 68. Roller-type engagement device 40 is secured to second pawl leg segment 66 of pawl 38 and includes a pair of oppositely-disposed sidewalls 70 defining a cage 72, and a roller or bearing, shown as a spherical ball bearing 74 that is retained by cage 72 within aligned roller slots 76 formed in sidewalls 70. An illustrative example of a latch with a bearing is described in United States patent application number 2020/0370346 entitled “Automotive latch including bearing to facilitate release effort” the entire contents of which are incorporated herein by reference. Pawl 38 is pivotable between a ratchet releasing position (FIG. 3B) and a ratchet holding position (FIGS. 3A, 3C and 3D). Pawl 38 is normally biased toward its ratchet holding position by a pawl biasing member, indicated by arrow 80.

As shown in FIG. 3B, pawl 38 is held in its ratchet releasing position when ratchet 36 is located in its striker release position due to engagement of ball 74 with pawl engagement surface 68 on pawl 38 and with edge surface 54 on ratchet 36, whereby a released operating state for latch mechanism 32 is established. As shown in FIG. 3C, ball 74 is in engagement with pawl engagement surface 68 on pawl 38 and with secondary latch notch 52 on ratchet 36 so as to cause pawl 38, now located in its ratchet holding position, to hold ratchet 36 in its secondary striker capture position. In this orientation, striker 20 is retained between striker guide channel 44 and fishmouth slot 48 in latch frame plate 34 to hold door 16 in a partially-closed position and establish a secondary latched state for latch mechanism 32. Finally, FIGS. 3A and 3D illustrate pawl 38 located in its ratchet holding position with ball 74 in engagement with pawl engagement surface 68 on pawl 38 and with primary latch notch 50 on ratchet 36 such that pawl 38 holds ratchet 36 in its primary striker capture position so as to hold door 16 in its fully-closed position and establish a primary latched operating state for latch mechanism 32.

Latch release mechanism 33 is shown schematically to be connected to first pawl leg segment 64 of pawl 38. Latch release mechanism 33 functions to cause movement of pawl 38 from its ratchet holding position into its ratchet releasing position when it is desired to shift latch mechanism 32 into its released operating state. An inside latch release mechanism (see schematic cable 81 in FIGS. 1 and 3A) connects inside handle 23 to latch release mechanism 33 to permit manual release of latch mechanism 32 from inside the passenger compartment of vehicle 10. Likewise, an outside latch release mechanism (see schematic cable 82) connects outside handle 21 to latch release mechanism 33 to permit manual release of latch mechanism 32 from outside of vehicle 10.

Power release actuator 22 is operably coupled to pawl 38, either directly or indirectly, such as via latch release mechanism 33, wherein latch release mechanism 33 can be provided as a latch release lever, link arm, or the like. Actuation of power release actuator 22 causes latch release mechanism 33 to move pawl 38 from its ratchet holding position to its ratchet releasing position. As will be detailed, power release actuator 22 is an electromagnetic actuator. A ratchet switch lever (not shown) can be mounted to ratchet 36 and works in cooperation with a ratchet release sensor (not shown) to provide a “door open” signal when ratchet 36 is located in its striker release position and a secondary latched sensor (not shown) to provide a “door ajar” signal when ratchet 36 is located in its secondary striker capture position. As is well known, these sensor signals can be used by a latch control system to control operation of power release actuator 22.

In the non-limiting configuration of FIGS. 3A-3D, power release actuator 22 interacts with latch mechanism 32 to provide a “power release” function by actuating (moving) latch release mechanism 33 to cause pawl 38 to move from its ratchet holding position into its ratchet releasing position. However, power release actuator 22 could additionally, or alternatively, be configured to provide one or more other “powered” functions provided by latch mechanism 32 such as, for example, power cinch or power lock/unlock functions.

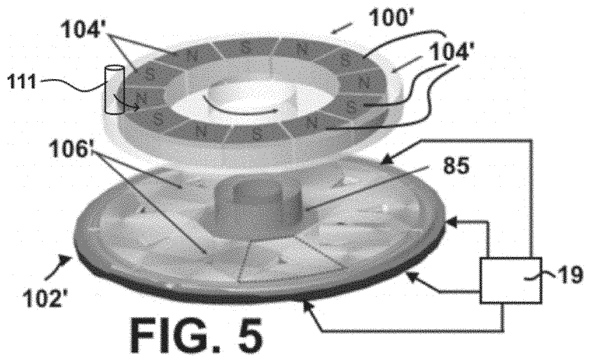

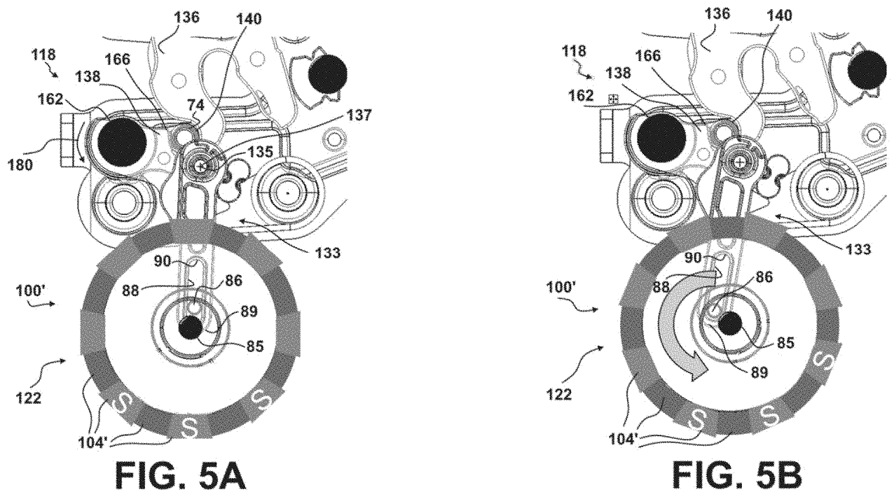

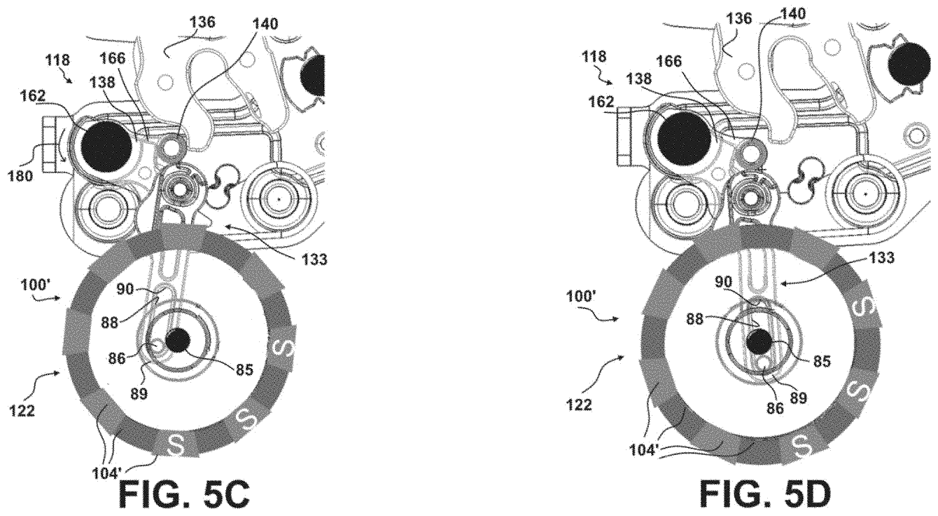

Now referring to FIGS. 4 and 4A, the power release actuator, and referred to hereafter as electromagnetic actuator 22, is an actuator operable for providing motion between a stationary part and a moveable part through control of a magnetic field magnetically coupling the stationary part and the moveable part. Control of the magnetic field to impart motion between the moveable part and the stationary part may be achieved using electronic commutation for supplying alternating power, such as alternating current, to vary the magnetic field. Electromagnetic actuator 22 is not configured for mechanical commutation using brushes. Electromagnetic actuator 22 may be a rotary type having a rotor as the moveable part and a stator as the stationary part for generating rotary motion at an output, such as at the output shaft 111 coupled to rotor shaft corresponding to a rotation of the rotor (see FIG. 5 for example). Electromagnetic actuator 22 may be a linear type having a linearly travelling rotor as the moveable part (as one example being the magnets 104 supported on link 100 as will be described with reference to FIG. 4) and a stator as the stationary part (as one example the second member 102 of FIG. 4) generating linear motion of an output member, such as the linear motion first member 100). Electromagnetic actuator 22 may be a brushless motor, without a mechanical commutator having brushes. Electromagnetic actuator 22 may be a stepper motor. Electromagnetic actuator 22 is electrically driven by a source 19 of electrical power supplied from the source 19 to the electromagnetic actuator 22 over an electrical connection or signal line 17, such as line 28b, for energizing the electromagnetic actuator 22. Electromagnetic actuator 22 illustratively includes a first member 100 and a second member 102 configured for movement relative to one another. To facilitate relative movement between first and second member 100, 102, a plurality of permanent magnets 104 are fixed to one of the first member 100 and second member 102, and shown in a non-limiting embodiment as to the first member 100, and a plurality of electromagnetic coils 106 are fixed to the other of the first member 100 and the second member 102, and shown in a non-limiting embodiment as to the second member 102. The plurality of electromagnetic coils 106 are configured in electrical communication with the source 19 of electric current of alternating first and second polarities such that the electromagnetic coils 106 are energizable to attract the plurality of permanent magnets 104 in response to the first polarity electric current and to repel the plurality of permanent magnets 104 in response to the second polarity electric current to move the first member 100 relative to the second member 102. The electromagnetic coils 106 are configured in operable communication with the controller, also referred to as electronic control unit 110 (ECU), for example via the driver 27a as controlled by the controller 110, for selective and precisely timed energization of electromagnetic coils 106, wherein ECU 110 and the driver 27a may be provided on a printed circuit board 112 (PCB) disposed within latch housing 30. Accordingly, the ECU 110 can be contained within latch housing 30 as a component of PCB 112, though it is contemplated herein that ECU 110 could be provided externally from latch housing 30, as desired. PCB 112 can have a backup power device 20a, such as (supercapacitor(s) or battery(ies), to selectively power electromagnetic coils 106, though electromagnetic coils 106 can further be connected in electrical communication with an external supply of power, such as a battery 4a or alternator 4a, by way of example and without limitation.

Now referring to FIG. 4A, there is shown a power actuation system 99 for a closure latch assembly 18 including a latch mechanism 32, 132, including an electromagnetic actuator 22 operably coupled to the latch mechanism 32, 132, a source of electric power 19 configured in electrical communication, for example via signal line 28b, with said electromagnetic actuator 22. The source 19 is adapted to control a supply of alternating electric power to energize the electromagnetic actuator 22 for actuating the latch mechanism 32, 132.

Now referring to FIG. 4B, there is shown a power actuation system 99 for a closure latch assembly 18 including a latch mechanism 32, 132, including an electromagnetic actuator 22 operably coupled to the latch mechanism 32, 132, a source of electric power 19 configured in electrical communication, for example via signal line 28b, with said electromagnetic actuator 22. The source 19 is adapted to control a supply of alternating electric power to energize the electromagnetic actuator 22 for actuating the latch mechanism 32, 132. The source 19 is adapted to detect a position of the electromagnetic actuator 22, for example using a feedback signal line 29a from the electromagnetic actuator 22 to the source 19, and for example from the electromagnetic actuator 22 to the controller 110. The signal line 29a may provide signals for use by the controller 110 for detecting the position of the electromagnetic actuator 22. For example signal line 29a may be coupled to a sensor 31, which may be a hall sensor, an encoder, an induction sensor, as examples which may be integrated with the electromagnetic actuator 22, or which may be provided adjacent to the electromagnetic actuator 22, as shown in FIG. 4C. In a possible configuration, feedback from the electromagnetic actuator 22 may be provided using signal line 28b without the need for a separate signal line 29a, such as may be used in a sensor-less position detection configuration of the controller 110 by sensing noise on the signal line 29a, as shown in FIG. 4D.

Referring to FIG. 5 at least, in one possible configuration, the electromagnetic actuator 22, 122, 222 may be configured as a stepper motor and controlled over a series of discrete positions corresponding to alignment of the poles of the stator 102′ with the poles of the rotor 100′ of the stepper motor configuration when energized by using for example a pulsed drive signal. The stepped motion of the rotor 100′ in a stepper motor configuration moves the pawl 138 in corresponding steps, and may cause the pawl 138 to stop at one of the discrete steps. Since a pulsed drive signal is supplied to the electromagnetic actuator 22, 122, 222 as a stepper motor with a known number of pulses where each pulse moves the rotor 100′ of the stepper motor to a position, such as over an known angular position, the position the rotor 100′ will be known at all moments and therefore the position of the pawl 138, as determined by a controller 110 for example, will be known at all moments by determining the number of pulses to rotate the rotor 110′ of the electromagnetic actuator 22, 122, 222 as a stepper motor. As a result, a separate position sensor for sensing either the position of the rotor 100′ of the stepper motor such as an encoder, and/or for sensing a position of the pawl 138, such as by using a hall sensor mounted to the pawl 138, is not required. Electronic control unit 110 may be therefore configured detect the position of the pawl 138 in response to detecting the position of the electromagnetic actuator 22, 122, 222 by using such an open loop position feedback configuration whereby the control steps to move the electromagnetic actuator 22, 122, 222 may be used to determine the position of the electromagnetic actuator 22, 122, 222, (for example by the controller 110 counting the number of pulses, where each pulse may move the rotor 100′ by a constant angular position, and thus by the controller determining the number of pulses to move the rotor 100′ a number angular degrees, the final position of the rotor 100′ may be determined, and in turn the position of the pawl 138, due for example to the direct connection between the electromagnetic actuator 22, 122, 222 and the pawl 138, may be deduced or determined. Alternatively, or additionally, electronic control unit 110 may be configured detect the position of the pawl 138 in response to using a sensor (see. FIGS. 4B, 4C) for detecting the position of the electromagnetic actuator 22, 122, 222 by using a closed loop position feedback configuration whereby the absolute position of the electromagnetic actuator 22, 122, 222 (e.g. the rotor 100′ of the electromagnetic actuator 22, 122, 222) may be used to deduce the position of the pawl 138, due for example to the direct connection between the electromagnetic actuator 22, 122, 222 and the pawl 138. In a possible configuration, a sensor for sensing the position of the pawl 138, such as a magnet 137 mounted to the pawl 138 detected by a hall sensor coupled to the controller 110, may be provided in a configuration where a lost motion connection is provided between the pawl 138 and the stepper motor. Advantageously, employing a stepper motor configuration of electromagnetic actuator 22, 122, 222 may provide a hold open function, or in other words the stepper motor may maintain the pawl 138 in the ratchet released position for an extended period of time against the pawl biasing member, indicated by arrow 80, which may be provided through the magnetic coupling or attraction between the rotor 100′ and stator 102′ of the stepper motor, or detent torque, which may occur when the stepper motor is not energized (due to the non-energized magnetic attraction between the magnets and metallic coils of the stepper motor for example), or which may be provided through a minimally (non-powered movement) energized magnetic coupling or attraction between the rotor 100′ and stator 102′ of the stepper motor which may occur when the stepper motor is energized, but requiring less energy than would be required to move the rotor 100′. Upon the controller 110 determining to cease the hold open operation to return the pawl 138 to the ratchet holding position, the stepper motor may be energized may be energized to move the pawl 138 towards the ratchet holding position, which may involve moving the link 133 out of an over center position (see FIG. 5D for example) to a position sufficient where the pawl biasing member, indicated by arrow 80 overcomes the detent torque of the stepper motor if the stepper motor is not energized. At such an over-center position, the stepper motor may be deenergized and return of the pawl 138 occurs under spring bias force only. A similar holding function for configurations of electromagnetic actuator 22, 122, 222 having magnets and coils when the electromagnetic coils are not energized, may be provided where the electromagnetic actuator 22, 122, 222 is configured having at least one of the electromagnetic coils and at least one of the permanent magnets being magnetically attracted to each other when the coils are not energized for resisting movement of the pawl 138, such as for resisting the motion of the pawl 138 towards the ratchet holding position, which may be caused by the pawl bias.

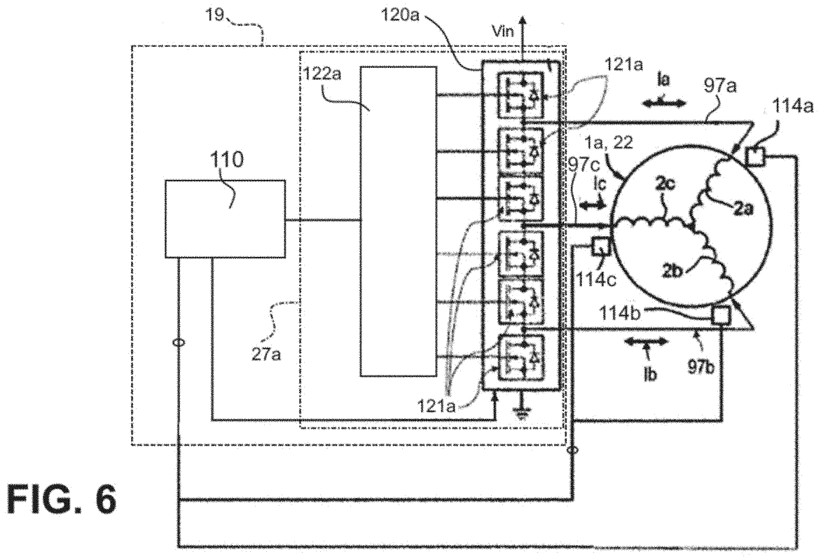

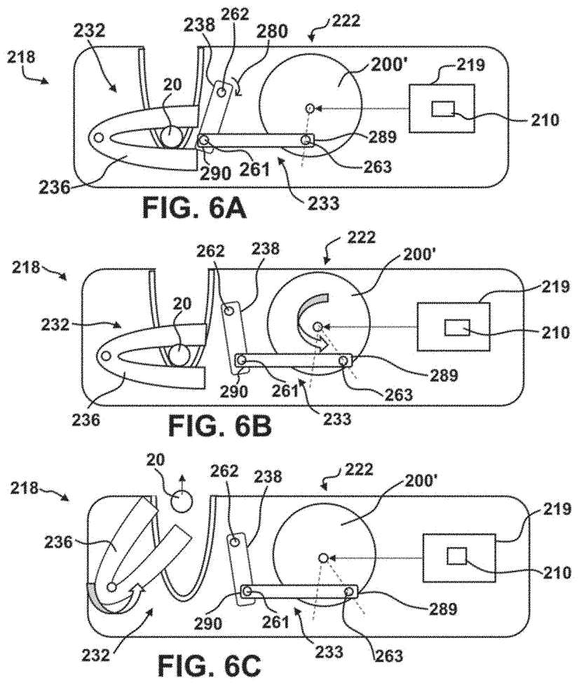

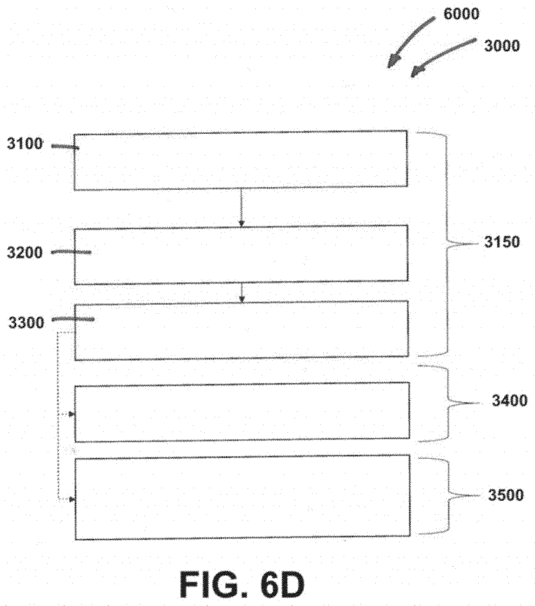

Now referring to FIG. 6, the electromagnetic actuator 22 as shown schematically in FIG. 6 may be a brushless DC (Direct Current) electric motor 1a or simply brushless electric motor in one illustrative example and may include a stator and number of stator windings 2a, 2b, 2c (three in the example, connected in a star configuration), and a rotor, having two poles (‘N’ or North and ‘S’ or South) in the example but more are possible, which is operable to move, or rotate, with respect to the stator windings 2a, 2b, 2c. The rotor may be connected to an output shaft such as motor shaft defining an actuator axis 85 for example. Control of the brushless electric motor 1a envisages electric commutation including electrical periodical switching of the generated or phase currents Ia, Ib, Ic flowing in the stator windings 2a, 2b, 2c as energized by a DC power supply (e.g., voltage supply Vin of battery 4a) in electrical communication with the windings 2a, 2b, 2c, as conditioned by the driving circuity, in order to maintain the rotation of the rotor via the resulting magnetic interaction. For example, the source 19 of the electrical power for the electromagnetic actuator 22 may include the controller 110 and the driver 27a as controlled by the controller 110. Driver 27a may include a three-phase inverter 120a, and a PWM (Pulse Width Modulation) unit 122a coupled to the three-phase inverter 120a, which is coupled to the phase stator windings 2a, 2b, 2c. The three-phase inverter 120a includes three pairs of power transistor switches 121a for each stator winding 2a, 2b, 2c, which are controlled by the PWM unit 122a so as to drive the respective phase voltages either at a high (ON) or a low (OFF) value, in order to control the average value of related voltages/currents energizing the stator windings 2a, 2b, 2c. When the stator windings 2a, 2b, 2c are energized in a sequential order and magnitude, as determined by the controller 110 controlling the PWM unit 122a and the three-phase inverter 120a, a moving magnetic flux is generated by the stator windings 2a, 2b, 2c which interacts with the magnetic flux generated by the permanent magnetic rotor to cause the rotor to rotate in a desired relation to magnetic flux. Position of the rotor during its rotation in order to control the energizing voltage/current pattern to be applied to the windings 2a, 2b, 2c, also known as electrical commutation, may be required. Accordingly, Hall sensors, an encoder, induction sensor, or other kind of position sensors, shown schematically as 114a, 114b, 114c in a hall sensor configuration, are circumferentially arranged with respect to the stator windings 2a, 2b, 2c (e.g., with an angular distance of 120° of separation between them), in order to detect the position of the rotor, electrically communicate the detected signals to the controller 110. Other techniques for ascertaining the position of the rotor may be provided. Control of the brushless electric motor 1a, 22 may be implemented for example in a sinusoidal drive mode, whereby the brushless electric motor 1a, 22 is supplied by three-phase pulse width modulation (PWM) voltages modulated to obtain phase currents Ia, Ib, Ic of a sinusoidal shape in the stator windings 2a, 2b, 2c, or coils. With this sinusoidal commutation, all three electrical lines 97a, 97b, 97c connected with the stator windings 2a, 2b, 2c and the PWM unit 122a, are permanently energized with sinusoidal currents Ia, Ib, Ic, that are 120 degrees out of phase with each other. The electric commutation process of switching the current flowing through the stator windings 2a, 2b, 2c, is calculated by the controller 110 controlling the PWM unit 122a and inverter 120a (comprising power MOSFETs 121a). The electromagnetic actuator 22 as a stepper motor may be controlled in a similar manner, adapted for an open loop configuration, and the driver 27a configured as a chopper driver for example. Source 19 may therefore be configured for supplying a chopped signal for the actuator 22 as a stepper motor. The source of electric power 19 and the electromagnetic actuator 22 may be provided within the latch housing 30. The source of electric power 19 and the electromagnetic actuator 22 may be provided within a sub-housing within the latch housing 30. The sub-housing may be formed from metal for insulating against electromagnetic noise within the interior of the sub-housing. In another possible configuration, the power source 19 may be adapted to control the actuator 22 using a Field Oriented Control (FOC) technique, or vector control technique.

The latch mechanism 32 is operably coupled to the first member 100 to perform at least one of the following actuations in response to movement of the first member 100 relative to the second member 102: move the pawl 38 between its ratchet holding position and its ratchet release position; releasably lock the pawl 38 against movement from its ratchet holding position to its ratchet release position; and cinch the ratchet 36 to its striker capture position. In the embodiment illustrated, by way of example and without limitation, movement of the first member 100 relative to the second member 102 via energization of electromagnetic coils 106 of the electromagnetic actuator 22 causes the latch release mechanism 33 to move the pawl 38 between the ratchet holding position and the ratchet release position.

As shown in FIG. 4, electromagnetic actuator 22 is illustratively shown as a linear brushless motor configuration having a first member 100 is configured to move to and fro along a straight linear path relative to second member 102. Second member 102 is shown having a slide channel, referred to hereafter as channel 116, and the first member 100 is configured to slide in a close, loose fit within the channel 116 in response to energization of electromagnetic coils 106. The electromagnetic coils 106, creating poles when energized, extend, in fixed relation to second member 102, along opposite sides of the channel 116 in equidistantly spaced relation with one another along each side, and the permanent magnets 104 extend, in fixed relation to first member 100, along opposite sides of first member 100. The permanent magnets 104 are provided including a plurality of opposite polarity permanent magnets 104 arranged in alternating polarities relative to one another in equidistantly spaced relation with one another along each side. Accordingly, each side has opposite polarity permanent magnets 104. Upon energization of electromagnetic coils 106, the first member 100 is caused to slide within channel 116 along the direction of arrow 118, thereby pivoting pawl 38 against the bias of biasing member 80, and thus, moving pawl 38 to its ratchet release position. Upon de-energization of electromagnetic coils 106, biasing member 80 acts to return pawl 38 to its ratchet holding position, thereby causing first member 100 to slide within channel 116 in a direction opposite arrow 118 to its rest position via the interconnection of latch release mechanism 33 with pawl 38.

With actuation of closure latch assembly 18 being controlled electronically via electromagnetic actuator 22, without a mechanical mechanism, e.g. gears, gear-train, and the like, driving the release operation of pawl 38, reduced friction and reduced noise results, and precise position control and monitoring of pawl 38 and ratchet 36 is provided via communication of electromagnetic actuator 22 with ECU 110. Accordingly, the need for separate position sensors to sense the position(s) of pawl 38 and/or ratchet 36 is negated, thereby reducing the overall package size, complexity of design and cost of closure latch assembly 18. Of course, further reduction of package size, complexity of design and cost of closure latch assembly 18 is provided by negating the use of an electric motor and gear train ordinary found in latch assemblies.

In FIGS. 5A-5D, a closure latch assembly 118 constructed in accordance with another embodiment of the disclosure is shown, wherein the same reference numerals, offset by a factor of 100 or primed (′), are used to identify like features.

The closure latch assembly 118 includes a latch release mechanism 133 operably connecting power release actuator 122 to pawl 138 without a purely mechanical mechanism, similar to that discussed above for closure latch assembly 18, with the notable distinguishing aspects over closure latch assembly 18 directed primarily to the latch release mechanism 133 and the power release actuator 122 being discussed hereafter.

Closure latch assembly 118 includes a latch mechanism 132 having a ratchet 136 and pawl 138, as discussed above. Pawl 138 is pivotably mounted to a latch frame plate, as discussed above, about a pawl pivot post 162 and includes a leg segment 166 extending away from pawl pivot post 162. A roller-type engagement device 140, as discussed above, is secured to leg segment 166 of pawl 138. Pawl 138 is pivotable between a ratchet releasing position (FIG. 5D) and a ratchet holding position (FIG. 5A and 5B), wherein pawl 138 is normally biased toward its ratchet holding position by a pawl biasing member 180 (shown schematically in FIG. 5A).

In this non-limiting configuration, power release actuator 122 interacts with latch mechanism 132 to provide a “power release” function by actuating latch release mechanism 133 to cause pawl 138 to move from its ratchet holding position to its ratchet releasing position. However, power release actuator 122 could additionally, or alternatively, be configured to provide one or more other “powered” functions provided by latch mechanism 132, such as, for example, power cinch or power lock/unlock.

Power release actuator 122 is provided as an electromagnetic actuator. Power release actuator, referred to hereafter as electromagnetic actuator 122, includes a rotor, referred to hereafter as first member 100′, and a stator, referred to hereafter as second member 102′ (FIG. 5), configured for movement relative to one another in response to a magnetic force selectively imparted therebetween, with no mechanical interconnection (e.g. gears) being present between first and second members 100′, 102′, thereby minimizing the generation of noise and friction therebetween as they move relative to one another. To facilitate relative movement between first and second members 100′, 102′, a plurality of permanent magnets 104′ are fixed to one of the first and second member 100′, 102′, and shown in a non-limiting embodiment as to the first member 100′, and a plurality of electromagnetic coils 106′ are fixed to the other of the first and second member 100′, 102′, and shown in a non-limiting embodiment as to the second member 102′. The plurality of electromagnetic coils 106′ are configured in electrical communication with a source of electric current, as discussed above for electromagnetic coils 106, with an ECU 110′ being operative to signal electromagnetic coils 106′ to be energized and de-energized in response to a signal from a user, such as from one of the outside and/or inside handles 21, 23 and/or via a remote device, such as a key fob, by way of example and without limitation.

The first member 100′ is generally disc-shaped and is configured to move rotatably along an arcuate path relative to the second member 102′ upon energization of the electromagnetic coils 106′. As shown, the arcuate path of first member 100′ is circular, as first member 100′ is caused to rotate about an axis 85 in response to being driven by energized electromagnetic coils 106′, wherein electromagnetic coils 106′ are arranged and fixed in a circle in radially aligned, axially spaced relation with permanent magnets 104′ relative to axis 85. Accordingly, permanent magnets 104′ and electromagnetic coils 106′ are spaced radially from axis 85 substantially the same distance, but axially spaced from one another. To facilitate actuating movement of pawl 138, first member 100′ has an actuation feature, also referred to as drive member, and shown as a drive pin 86, extending in fixed relation outwardly therefrom, shown as extending generally transversely from a generally planar face of generally planar, disc-shaped first member 100′.

The latch release mechanism 133 is provided as a link arm operably coupling the first member 100′ to the pawl 138. The link arm 133 has an elongate slot 88 extending between a first drive end 89 and a second drive end 90, wherein drive pin 86 is disposed in and configured for sliding movement along slot 88 between the first drive end 89 and the second drive end 90. Accordingly, link arm 133 connects pawl 138 with drive pin 86 of first member 100′. Link arm 133 is shown as directly coupling drive pin 86 to pawl 138 to form a lost motion connection therebetween, via sliding movement of drive pin 86 along slot 88; however, it is contemplated that by operably connecting pawl 138 with drive pin 86 that addition levers or mechanisms could be incorporated therebetween. A lost motion slot, such as slot 88, may be provided between the pawl 138 and the link arm 133 in an alternate configuration, where the drive pin 86 is fixed for rotation within a circular aperture in the link arm 133 for example. Link arm 133 is shown connected to the pawl 138 about a fixed pivot axis 135, such as via a post extending from the pawl 138 for rotatable receipt within a circular aperture formed in the link arm 133 in the configuration where the drive pin 86 is coupled to the slot 88.

As shown in FIGS. 5B-5D, rotation of first member 100′ in a counterclockwise direction CCW from a home position (FIG. 5A) to a released position (FIG. 5D) via energization of electromagnetic coils 106′, establishing a magnetic drive force between electromagnetic coils 106′ and permanent magnets 104′, causes drive pin 86 to rotate conjointly in fixed relation with first member 100′ and move within and traverse slot 88 into engagement with first drive end 89 to drive link arm 133 and drive pawl 138, against the bias of pawl biasing member 180, from its ratchet holding position (FIG. 5A) to its ratchet releasing position (FIG. 5D). Following completion of power release, electromagnetic actuator 122 is commanded via ECU 110′ to rotate first member 100′ in the opposite clockwise direction, via selective energization of second member 102′, back to its home position so as to reset latch release mechanism 133 to subsequently allow pawl 138, via bias imparted by pawl biasing member 180, to move back into its ratchet holding position.

During actuation of closure latch assembly 118, lost motion is provided between movement of first member 100′ and movement of pawl 138 due to the lost motion travel of drive pin 86 in and along slot 88 which, in turn, results in enhanced release efficiency and reduced drive force required to drive first member 100′ due to a buildup of inertia of first member 100′ and drive pin 86 prior to engaging first drive end 89 and initiating movement of pawl 38′. As shown in FIGS. 5A and 5B, upon selectively energizing electromagnetic actuator 122 (FIG. 5B) and driving first member 100′ rotatably about axis 85, drive pin 86 is allowed to slide freely within slot 88 prior to driving link arm 133 linearly, and then, during initial engagement of drive pin 86 against first drive end 89 of slot 88, the initial movement of link arm 133 is pivotal about a pin 92 connecting link arm 133 to pawl 138, and thus, does not pull on pawl 138, which all together allows inertia to build in first member 100′. Then, upon initial driving of link arm 133 linearly relative to pawl pin 162 defining a pawl pivot axis, the buildup of inertia via speed increase of first member 100′ facilitates moving pawl 138 from its ratchet holding position, against the bias of pawl biasing member 180, toward its ratchet release position. Upon reaching a full travel position (FIG. 5D), first member 100′ has been driven between about 180-190 degrees, whereat link arm 133 has been rotated to an on-center (on-center equals 180 degrees or an over-center position being greater than 180 degrees) relative to alignment with axis 85, and thus, pawl biasing member 180 is effectively holding first member 100′ in its full travel position by pulling on first member 100′ being held by drive pin 86. Thus, no additional levers or components are needed to provide a full travel position or snow load function. As discussed above for electromagnetic actuator 22, electromagnetic actuator 122 does away with the need for separate position sensors to sense the position(s) of pawl 138 and/or ratchet 136, thereby reducing the overall package size, complexity of design and cost of closure latch assembly 118. As illustratively shown in FIGS. 5A to 5D, pawl pivot axis 162 is parallel to the axis 85 (add to FIG. 5) of the electromagnetic actuator 122, due to the compact design of electromagnetic actuator 122, electromagnetic actuator 122 can be positioned within the same plane as the pawl 138 and adjacent to the pawl 138 without having to accommodate any paring of gears compared to known worm gear and brushed DC motor configurations having a motor shaft axis extending within the plane. The electromagnetic actuator 122 in contrast may be provided as having a compact dimension along its axis 85 with the axis 85 extending out of the plane of the pawl 138.

FIG. 4 and FIG. 5 illustrate the use of an exemplary direct drive connection between the electromagnetic actuator 22 and the pawl 138, in that no reductions, for example separate gear reduction mechanisms, are provided so that the motion of the pawl 138 is directly related to the motion of the actuator 122. With reference to FIG. 4, the first member 100 is coupled to the pawl 138 such that motion of the first member 100 corresponds to a similar driven motion of the pawl 138. With reference to FIG. 5, the first member 100 is coupled to the pawl 138, for example via the link arm 133, such that motion of the first member 100, at least in the opening or releasing direction, corresponds to a similar driven motion of the link arm 133 and of the pawl 138. As another possible example of a direct drive connection, drive pin 86 may directly engage with pawl 138 for pivoting the pawl 138. As another possible example of a direct drive connection, drive pin 86 may move one or more levers coupled to pawl 138.

As illustrated in FIGS. 6A-6C, a closure latch assembly 218 constructed in accordance with another embodiment of the disclosure is shown, wherein the same reference numerals, offset by a factor of 200 and/or primed (′), are used to identify like features.

The closure latch assembly 218 includes a latch release mechanism 233 operably connecting power release actuator 222 to pawl 238 without a mechanical gear set, or in other words without using gears, (for example no gears are provided between the electromagnetic actuator output and the pawl such as no worm gears, spur gears, helical gears, bevel gears are provided for providing gear reduction, torque multiplication, or directional changes), similar to that discussed above for closure latch assembly 18, 118, with the notable distinguishing aspects over closure latch assembly 18, 118 directed primarily to the latch release mechanism 233 and the power release actuator 222 being discussed hereafter.

Closure latch assembly 218 includes a latch mechanism 232 having a ratchet 236 and pawl 238, as discussed above. Pawl 238 is pivotably mounted to a latch frame plate, as discussed above, for pivotal movement about a pawl pivot post 262. Pawl 238 is pivotable between a ratchet releasing position (FIGS. 6B and 6C) and a home position, also referred to as ratchet holding position (FIG. 6A), wherein pawl 238 is normally biased toward its ratchet holding position by a pawl biasing member 280 (shown schematically in FIG. 6A).

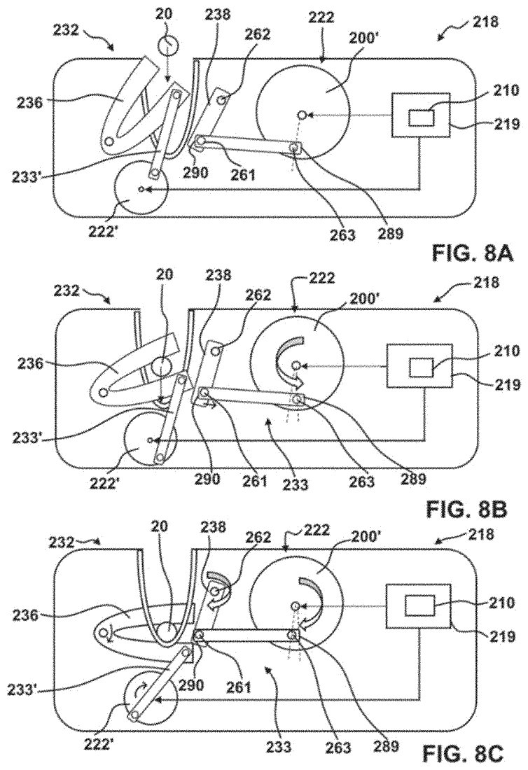

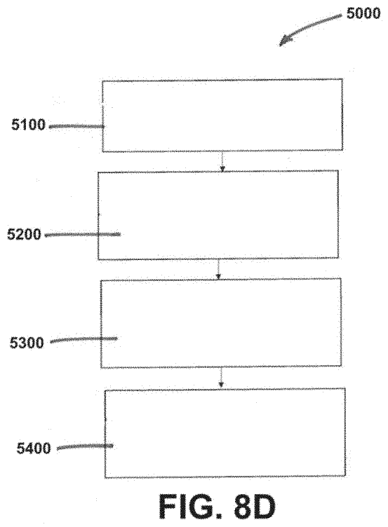

In this non-limiting configuration, power release actuator 222 interacts with latch mechanism 232 to provide a “power release” function by actuating latch release mechanism 233 to cause pawl 238 to move from its ratchet holding position to its ratchet releasing position. Further yet, a cinch actuator 222′ (FIGS. 8A-8C) may be additionally provided to provide a “power cinch” function of latch mechanism 232, which includes moving the ratchet 236 from a secondary striker capture position to a primary striker capture position as one example. The power release and power cinch functions are performed via signals supplying power from the power source 219, which is illustratively controlled by the Electronic Control Unit (ECU) 210, or controller, that is configured to detect the precise position of internal latch components, such as ratchet 236 and/or pawl 238, by way of example and without limitation, either directly, or indirectly, such as via directly sensing the position of the power release actuator 222, which is connected to pawl 238, and cinch actuator 222′, which is connected to ratchet 236, as discussed further below, to initiate and complete the respective power release and power cinch functions. Source 219 when configured to control the cinch actuator 222′ may be adapted with an additional drive circuit, similar to driver 27a described herein above, as controlled by the controller 210. In a possible configuration, closure latch assembly 218 may be provided only with a cinch actuator 222′ and controller 210 adapted to drive the cinch actuator 222′.

Power release actuator 222 and cinch actuator 222′ are provided as electromagnetic actuators, also referred to as actuators, such as a continuous drive BLDC brushless motor, a linear electromagnetic actuator, or as a stepper drive BLDC brushless motor, also referred to as stepper motor for example. It is to be recognized that either type of electromagnetic actuator can be used in any of the embodiments of the present disclosure. Power release actuator 222 and cinch actuator 222′ each include a rotor (illustrated with reference to power release actuator 222, through cinch actuator 222′ can be the same), referred to hereafter as first member 200′, and a stator, referred to as second member (not shown), similar to that as discussed above, and thus, further discussion here is believed unnecessary.

The latch release mechanism 233 is provided as a link arm 233 operably coupling the second member of release actuator 222 to the pawl 238 via direct, interlinked connection of rotor 200′ to pawl 238. The link arm 233 extends between a first end 289, which is pivotably coupled directly to rotor 200′, and a second end 290, which is pivotably coupled directly to pawl 238. Accordingly, link arm 233 connects pawl 238 with rotor 200′. Link arm 233 is shown as being pivotably connected directly to pawl 238 via a pin 261 and directly to rotor 200′ via a pin 263 to form a direct connection between pawl 238 and rotor 200′, such that movement of rotor 200′ causes direct, conjoint movement of pawl 238.

The power release actuator 222 is configured in operable communication with control unit 210 (ECU), or controller, for selective and precisely timed energization of electromagnetic coils of the stator, as discussed above, thereby causing concurrent movement of pawl 238 with rotor 200′, as desired, in a power release operation 3000 (FIG. 6D). ECU 210 can be provided on a printed circuit board (PCB), as discussed above for PCB 112, and thus, no further discussion is believed necessary. ECU 210 is able to sense the precise angular position of rotor 200′, which directly corresponds to the position of pawl 238, and thus, ECU 210 is able to determine the precise angular position of the pawl 238 and can signal power release actuator 222 to be energized to move pawl 238 to the desired position, including one of the ratchet holding positions and the ratchet releasing position, when desired. Further yet, ECU 210 can signal power release actuator 222 to be de-energized to stop movement of and hold pawl 238 in the desired position, when desired. As such, the precise position of pawl 238 can be controlled via communication between ECU 210 and power release actuator 222 without need of physical hard stops to locate pawl 238, which not only simplifies construction and reduces the cost of closure latch assembly 218, but also enhances performance, packaging and functionality of closure latch assembly 218, such as by reducing the space needed for internal components, thereby reducing package size, and eliminating a potential source of noise associated with a hard physical stop. Further yet, advance motion control of the pawl 138 may be provided, such as precise speed control of the pawl 138, precise position control of the pawl 138 such as stop and hold functionality (e.g. stop the pawl 138 at a particular position and hold the pawl in such a stopped position), non-powered hold functionality (e.g. at a pawl hold open position without energizing the actuator 222). Further yet, with the position of pawl 238 being able to be deduced by the position of the power release actuator 222 in an open feedback sensing configuration, such as by detecting a position of the rotor as one example, by communication between ECU 210 and power release actuator 222, further sensors, such as a Hall sensor or otherwise, are not needed, further reducing manufacturing complexity, cost and package size, and packaging configurations requiring a hall sensor to be positioned above or adjacent the pawl 238 e.g. next to magnet 137.

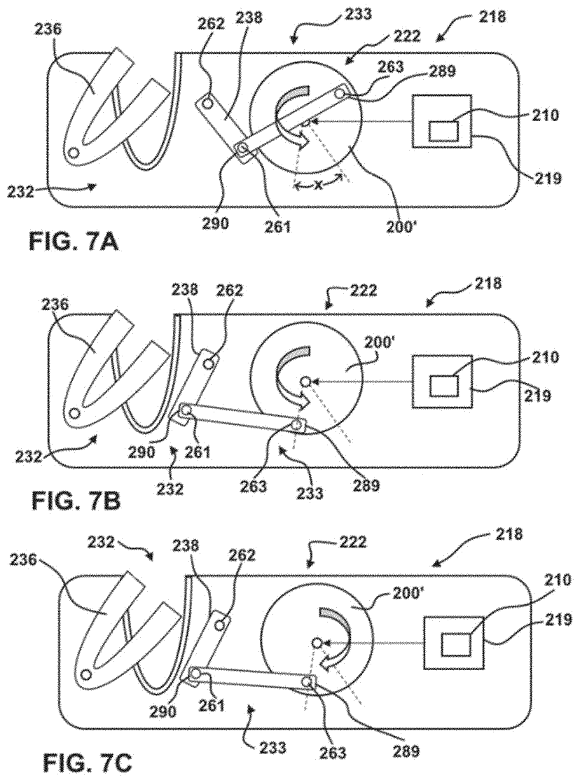

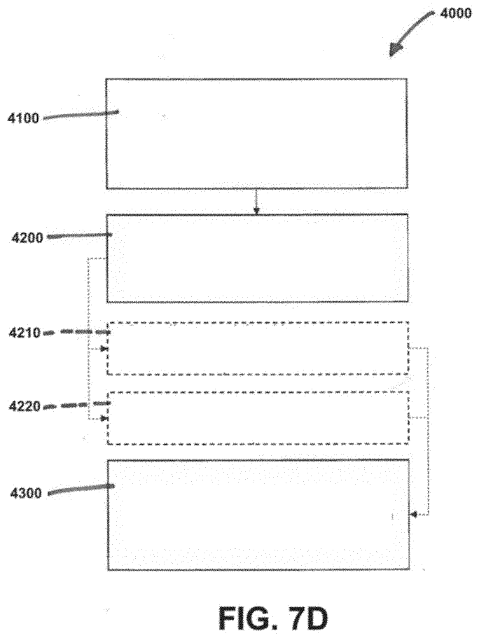

As shown in FIGS. 6B-6C, ECU 210 first receives a release signal at step 3100 (FIG. 6D) to initiate rotation of first member 200′ in first release portion 3150 of power release operation 3000 over a predetermined angular rotation, shown as being in a counterclockwise direction CCW from a home position (FIG. 6A) to a released position (FIG. 6C) via a signal being sent from the source 219 including the ECU 210 to electromagnetic actuator 222. Energization of electromagnetic actuator 222 causes counterclockwise rotation of first member 200′ to translate and oscillate link arm 233 and drive pawl 238 at step 3200 pivotably about pin 262, against the bias of pawl biasing member 280 (FIG. 6A), from its ratchet holding position (FIG. 6A), whereat ratchet 236 is held in its striker capture position, to its ratchet releasing position (FIG. 6C) at step 3300, whereat ratchet 236 is moved to its striker release position and whereat ECU 210 determines the position of electromagnetic actuator 222, via date received from electromagnetic actuator 222, corresponding to a pawl position corresponding to the ratchet releasing position without need of a hard stop feature for pawl 238. Following completion of power release of the ratchet 236 to its striker release position, as desired, at step 3400, electromagnetic actuator 222 can locate pawl 238 in any desired position, including holding pawl 238 in the released position for a predetermined (preset) period of time. Then, at step 3500, where electromagnetic actuator 222 is a stepper motor, ECU 210 can control the de-energization of electromagnetic actuator 222 to hold pawl 238 in the released position magnetically, thereby resulting in a non-powered hold open of pawl 238. The resetting operation 3000 can further include returning pawl 238 to its home or ratchet holding position, with FIGS. 7B and 7C illustrating different actuation movements, as discussed further hereafter.

The return of pawl 238 from its ratchet releasing position to its ratchet holding position in the reset operation 4000 initiates at step 4100 with the ECU 210 receiving a signal in the form of data received from electromagnetic actuator 222, whereupon a step 4200 ensues by causing rotation of first member 200′ over a set number of degrees for angular rotation to return pawl 238 to its home position. The return of pawl 438 to its home position can be caused at a step 4210 via continued rotation of first member 200′ in the counterclockwise direction CCW (FIG. 7B) or at a step 4220 via rotation of first member 200′ in the clockwise direction CW (FIG. 7C), via selective energization of second member. As such, with regard to FIG. 7B, first member 200′ rotates to its ratchet releasing position and then, as shown diagrammed in FIG. 7D, resets via continued rotation in the same direction back to its ratchet holding position over a span of 360 degrees in the counterclockwise direction CCW. Further, with regard to FIG. 7C, first member 200′ rotates a predetermined number of degrees X in the counterclockwise direction CCW to its ratchet releasing position and then, as diagrammed in FIG. 7D, resets via rotating the same number of degrees X in the clockwise direction CW back to its ratchet holding position. In each case, with pawl fixed for conjoint movement with electromagnetic actuator 222 over its full range of motion from power release through power reset, at step 4300 ECU 210 signals electromagnetic actuator 222 to rotate and stop over the predetermined number of degrees in response to position signals received from electromagnetic actuator 222.

In FIGS. 8A-8C, a cinching operation 5000 (FIG. 8D) is illustrated via communication of ECU 210 with cinch actuator 222′. As a result of the direct connection between the actuator 222 as controlled by the ECU 210 and the pawl 238, as discussed above, ECU 210, at step 5100, senses when pawl 238 movement has occurred as ratchet 238 pivots from the striker releasing position to the secondary striker capture position via engagement of striker 20 with ratchet 236 during a closing sequence, whereat pawl 236 moves to the secondary ratchet holding position. ECU 210 senses pawl 236 moving to its secondary ratchet holding position and, at step 5200, signals/energizes cinch actuator 222′ via an energy source, also referred to as source, to move ratchet 236 clockwise CW from its secondary striker capture position to its primary striker capture position (FIG. 8C). Then, at step 5300, ECU 210 receives a signal indicating pawl 238 being moved to its primary ratchet locking position, whereat ratchet 236 is returned to its primary striker capture position. Then, at step 5400, upon ratchet 238 being returned to its primary striker capture position, ECU 210, upon pawl 236 being indicated as being in its primary ratchet holding position, signals and deactivates (de-energizes) cinch actuator 222′. It is to be recognized that cinch actuator 222′ can be provided as discussed above for electromagnetic actuator 222 and that the connection between cinch actuator 222′ and ratchet 236 can be provided via a link arm 233′, as discussed above for link arm 233, to forcibly pivot ratchet 236 about a pin 242 from its secondary striker capture position to its primary striker capture position. When cinch actuator 222′ is deactivated, cinch actuator 222′ allows unencumbered, unrestricted movement of ratchet 238 about pin 242, as desired, such as during a release sequence.

It is further contemplated herein that link arm 233, 233′ can be provided as discussed above for link 133. Accordingly, the attributes discussed above with regard to link arm 133 can be attained by link arm 233, 233′.

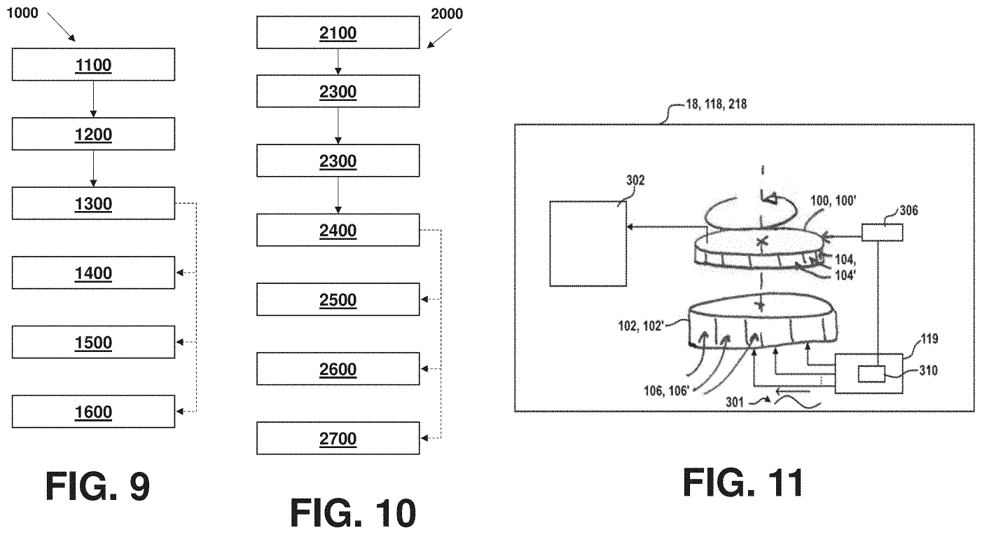

Now referring to FIG. 9, there is provided in accordance with an illustrative embodiment, a method 1000 of configuring a latch mechanism 32, 132 of a closure latch assembly 18, 118 of a motor vehicle closure panel 16 for actuation so that the latch mechanism 32, 132 performs at least one of the following: moves a pawl 38, 138 between a ratchet holding position and a ratchet release position; locks the pawl 38, 138 against movement from the ratchet holding position to the ratchet release position; and cinches a ratchet 36, 136 in a striker capture position, the method 1000 comprising: a step 1100 of providing an electromagnetic actuator 22, 122 including a first member 100, 100′, a second member 102, 102′, a plurality of permanent magnets 104, 104′ fixed to one of the first member 100, 100′ and the second member 102, 102′ and a plurality of electromagnetic coils 106, 106′ fixed to the other of the first member 100, 100′ and the second member 102, 102′; a step 1200 of configuring the plurality of electromagnetic coils 106, 106′ in electrical communication with a source of electric current 19, 119 of alternating first and second polarities such that the electromagnetic coils 106, 106′ are energizable to attract the plurality of permanent magnets 104, 104′ in response to the first polarity electric current and to repel the plurality of permanent magnets 104, 104′ in response to the second polarity electric current to move the first member 100, 100′ relative to the second member 102, 102′; and a step 1300 of operably coupling the first member 100, 100′ to a component of the latch mechanism 32, 132 for movement of the component in response to movement of the first member 100, 100′.

The method 1000 can further include a step 1400 of providing the component of the latch mechanism 32, 132 as a latch release mechanism 33, 133, such that movement of the first member 100, 100′ relative to the second member 102, 102′ via energization of the electromagnetic coils 106, 106′ causes the latch release mechanism 33, 133 to move the pawl 38, 138 between the ratchet holding position and the ratchet release position.

The method 1000 can further include a step 1500 of configuring the first member 100 to move linearly relative to the second member 102.

The method 1000 can further include a step 1600 of configuring the first member 100′ to rotate relative to the second member 102′.

Now referring to FIG. 10, there is provided in accordance with an illustrative embodiment, a method 2000 of manufacturing a closure latch assembly 18, 118, comprising: a step 2100 of supporting a ratchet 36, 136 in a housing 30 for movement between a striker capture position and a striker release position; a step 2200 of supporting a pawl 38, 138 in the housing 30 for movement between a ratchet holding position, whereat the ratchet 36, 136 is in the striker capture position, and a ratchet releasing position, whereat the ratchet 36, 136 is biased toward the striker release position, and biasing the pawl 38, 138 toward the striker release position; a step 2300 of supporting an electromagnetic actuator 22, 122 in the housing 30 with the electromagnetic actuator 22, 122 including a first member 100, 100′, a second member 102, 102′, a plurality of permanent magnets 104, 104′ fixed to one of the first member 100, 100′ and the second member 102, 102′ and a plurality of electromagnetic coils 106, 106′ fixed to the other of the first member 100, 100′ and the second member 102, 102′, the plurality of electromagnetic coils 106, 106′ being configured in electrical communication with a source 19, 119 of electric current of alternating first and second polarities, the electromagnetic coils 106, 106′ being energizable to attract the plurality of permanent magnets 104, 104′ in response to the first polarity electric current and to repel the plurality of permanent magnets 104, 104′ in response to the second polarity electric current to move the first member 100, 100′ relative to the second member 102, 102′; and a step 2400 of operably coupling a latch mechanism 32, 132 to the first member 100, 100′ and configuring the latch mechanism 32, 132 to perform at least one of the following in response to movement of the first member 100, 100′ relative to the second member 102, 102′: move the pawl 38, 138 between the ratchet holding position and the ratchet release position; lock the pawl 38, 138 against movement from the ratchet holding position to the ratchet release position; and cinch the ratchet 36, 136 to the striker capture position.

The method 2000 can further include a step 2500 of configuring the latch mechanism 32, 132 having a latch release mechanism 33, 133 such that movement of the first member 100, 100′ relative to the second member 102, 102′ via energization of the electromagnetic coils 106, 106′ causes the latch release mechanism 33, 133 to move the pawl 38, 138 between the ratchet holding position and the ratchet release position.

The method 2000 can further include a step 2600 of configuring the first member 100 to move linearly relative to the second member 102.

The method 2000 can further include a step 2700 of configuring the first member 100′ to rotate relative to the second member 102′.

Now referring additionally to FIG. 11, there is illustrated power actuation system 300 for a closure latch assembly 18, 118, 218 including a latch mechanism 302, the system 300 including an electromagnetic actuator 22, 122, 222 including a first member 100, 100′, 200′, a second member 102, 102′, a plurality of permanent magnets 104, 104′ fixed to one of the first member 100, 100′, 200′ and the second member 102, 102′ and a plurality of electromagnetic coils 106, 106′ fixed to the other of the first member 100, 100′, 200′ and the second member 102, 102′, a source 119 configured in electrical communication with the plurality of electromagnetic coils 106, 106′ for supplying alternating electric current 301 to energize the electromagnetic coils 106, 106′ for one of repelling and attracting the permanent magnets 104, 104′; and a controller 310, such as discussed above for ECU 110, 210, wherein the controller 310 is configured to control the supply of alternating electric current of the source 119 to impart movement between the first member 100, 100′, 200′ relative to the second member 102, 102′ and to prevent movement the first member 100, 100′, 200′ relative to the second member 102, 102′, and for example to hold the first member 100, 100′ and the second member 102, 102′ without movement relative to each other, either by energization of the electromagnetic actuator 22, 122, 222, or without energization electromagnetic actuator 22, 122, 222, where a holding force is provided by non-powered magnetic attraction between the coils 106, 106′ and the permanent magnets 104, 104′. The source 119, such as via the controller 310, may be in communication with an inside/outside switch, or with a Body Control Module (BCM), as examples for receiving a command to actuate the closure latch assembly 18, 118, 218 for example to unlatch the door, cinch the door, lock/unlock the door as examples. The power actuation system 300 may further include a position sensor 306, such as an encoder, or hall sensor, as but examples, configured to detect relative position and/or motion between the first member 100, 100′, 200′ and the second member 102, 102′, the position sensor 306 being in electrical communication with the controller 310. The electromagnetic actuator electromagnetic actuator 22, 122, 222 may be a piezoelectrical motor, and for example may be a linear piezoelectrical motor or a rotatory piezoelectrical motor. A rotatory piezoelectrical motor type is shown for shown in FIG. 5 for illustrative purposes only.The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly, comprising:
a latch mechanism including a ratchet and a pawl, said ratchet being moveable between a striker capture position and a striker release position, said pawl being moveable between a ratchet holding position, wherein said pawl in the ratchet holding position holds said ratchet in said striker capture position, and a ratchet release position, wherein said pawl in the ratchet release position releases said ratchet for movement toward said striker release position; and
an electromagnetic actuator;
wherein said electromagnetic actuator is operably coupled to the pawl and is adapted to move the pawl between said striker capture position and said striker release position in response to energization of the electromagnetic actuator.

2. The closure latch assembly of claim 1, wherein said electromagnetic actuator is a brushless motor.

3. The closure latch assembly of claim 2, wherein said brushless motor is operably coupled to the pawl using a direct drive connection.

4. The closure latch assembly of claim 2, wherein said brushless motor is operably coupled to the pawl without using gears.

5. The closure latch assembly of claim 4, further including a link arm operably coupling said electromagnetic actuator to said pawl.

6. The closure latch assembly of claim 5, wherein the link arm includes a lost motion connection between one of the pawl and the electromagnetic actuator.

7. The closure latch assembly of claim 5, wherein the electromagnetic actuator comprises a rotor and a stator, wherein the rotor is coupled to the link arm and rotates about an actuator axis, wherein the rotor axis is parallel to a pivot axis of said pawl.

8. The closure latch assembly of claim 1, wherein the electromagnetic actuator is a linear brushless motor.

9. The closure latch assembly of claim 1, wherein the electromagnetic actuator is a brushless stepper motor having a plurality of discrete positions, wherein the energization of the stepper motor causes the pawl to move to one of the discrete positions, wherein upon deenergization of the stepper motor the pawl is magnetically held at one of the discrete positions.

10. The closure latch assembly of claim 1, wherein the electromagnetic actuator includes a first member, a second member, a plurality of permanent magnets fixed to one of said first member and said second member and a plurality of electromagnetic coils fixed to the other of said first member and said second member, said plurality of electromagnetic coils being configured in electrical communication with a source of alternating electric current, said electromagnetic coils being energizable to attract said plurality of permanent magnets in response to said alternating electric current and to repel said plurality of permanent magnets in response to said alternating electric current to move said first member relative to said second member.

11. The closure latch assembly of claim 10, wherein when said electromagnetic coils are not energized, at least one of the electromagnetic coils and at least one of the permanent magnets are magnetically attracted for resisting movement of the pawl towards the ratchet holding position.

12. The closure latch assembly of claim 1, further including an electronic control unit configured in electrical communication with said electromagnetic actuator.

13. The closure latch assembly of claim 12, wherein said electronic control unit is configured to determine the position of said pawl.

14. The closure latch assembly of claim 13, wherein said electronic control unit is configured determine the position of the pawl based on detecting the position of said electromagnetic actuator.

15. The closure latch assembly of claim 10, further comprising a position sensor configured to detect a position and/or motion of said first member, said position sensor being configured in electrical communication with said electronic control unit.

16. The closure latch assembly of claim 1, wherein said latch mechanism includes a latch release mechanism, the latch release mechanism comprising a bearing positionable between the ratchet and the pawl, wherein movement of said first member relative to said second member via energization of said electromagnetic coils causes said latch release mechanism to move said pawl between said ratchet holding position and said ratchet release position.

17. A power actuation system for a closure latch assembly comprising a latch mechanism, comprising:
an electromagnetic actuator operably coupled to the latch mechanism; and
a source of electric power configured in electrical communication with said electromagnetic actuator;
wherein the source is adapted to control a supply of alternating electric power to energize the electromagnetic actuator for actuating the latch mechanism.

18. The power actuation system of claim 17, wherein the source of electric power is adapted to determine a position of the latch mechanism by detecting a position of the electromagnetic actuator.

19. A method of configuring a latch mechanism of a closure latch assembly of a motor vehicle closure panel for actuation, the method comprising the steps of:
providing an electromagnetic actuator including a first member, a second member, a plurality of permanent magnets fixed to one of the first member and the second member and a plurality of electromagnetic coils fixed to the other of the first member and the second member;
configuring the plurality of electromagnetic coils in electrical communication with a source of electric current such that the electromagnetic coils are energizable to attract the plurality of permanent magnets and to repel the plurality of permanent magnets to move the first member relative to the second member; and
operably coupling the first member to a component of the latch mechanism using a direct drive connection for movement of the component in response to movement of the first member.
